(19) United States
(12) Patent Application Publication
(10) Pub. No.: US 2004/0099593 A1
(43) Pub. Date: May 27, 2004

(54) Concurrent dialysate purification cartridge

(75) Inventors: Potito U. De Paolis, Los Angeles, CA (US); Saleh Salehmoghaddam, Los Angeles, CA (US)

Correspondence Address: OPPENHEIMER, OPPENHEIMER WOLFF & DONNELLY LLP, Suite 3800, 2029 Century Park East, Los Angeles, CA, 90067, US

(73) Assignee: Potito de Paolis

(21) Appl. No.: 10/304,159

(22) Filed: Nov. 25, 2002

(51) Int. Cl. C02F 1/42

(52) U.S. Cl. 210/266; 210/290

(57) ABSTRACT

The present invention discloses a new concurrent dialysate cartridge purification system for hemodialysis, particularly, a purification system whereby apatite and/or calcium phosphate and sodium polyphosphate are substituted for the standard zirconium oxide and zirconium phosphate, respectively. The concurrent dialysate cartridge purification system is comprised of multiple layers and at least one or more cation and/or anion exchange layer and at least one or more purification layer. One advantage of the concurrent dialysate cartridge purification system is the cost effectiveness of apatite and/or calcium phosphate and sodium polyphosphate.

### FIELD OF THE INVENTION

This invention relates generally to a dialysate purification cartridge for use in a hemodialysis system.

In one aspect, the present invention identifies and describes a dialysate system of anion exchange layers comprised of apatite and/or calcium phosphate. In another aspect, the present invention describes a dialysate system of cation exchange layers using sodium polyphosphate. Still in another aspect, the present invention identifies and describes a dialysate system of phosphate binding layer using calcium acetate and calcium carbonate.

Still in another aspect, the present invention describes a concurrent dialysate system comprising of one or more layers of the above.

### GENERAL BACKGROUND AND STATE OF THE ART

Renal failure is due to the inability of the kidney to carry on a normal function of excreting wastes and balancing the internal chemical environment of the body. Patients with end-stage renal disease (ESRD) have the possibility of an organ transplantation or dialysis. Dialysis treatment can be either hemodialysis or peritoneal dialysis.

In 1974 a patent was issued to Marantz et al. for a method of making granular zirconium hydrous oxide ion exchanges and as zirconium phosphate. U.S. Pat. No. 3,850,835 and U.S. Pat. No. 3,669,878 to Marantz et al. are hereby incorporated in its entirety by reference.

In 1981, a patent was issued to McArthur et al. for a sodium zirconium carbonate compound and the method of its preparation. U.S. Pat. No. 4,256,718 to McArthur et al. Is hereby incorporated in its entirety by reference. The use of zirconium carbonate compounds is very expensive. In aforementioned methods, an anion resin was needed to remove phosphates; thus hydrated zirconium oxide was used.

The above was incorporated into a portable hemodialysis system by Sorb Technology, Inc. (Oklahoma City, Okla.) and called the Regenerative Dialysis Sorbent, or the REDY sorbent system. In the REDY sorbent system, spent dialysis is purified by a sorbent cartridge and recirculated instead of being discarded. A water supply and drainage system is not needed, as only a small volume of dialysate is necessary.

A general description of REDY sorbent systems is given in Shapiro, W. “REDY Sorbent Hemodialysis System,” in A. R., Nissenson & R. N. Fine, “Dialysis Therapy,” (3d ed., Hanley & Belfus, Inc., Philadelphia, Pa., 2002), incorporated herein by this reference.

In brief, the REDY sorbent system consists of two components: a dialysis machine and a sorbent cartridge. The sorbent cartridge consists of five layers through which used dialysate passes: i) a purification layer consisting of activated charcoal; ii) an enzyme layer consisting of urease; iii) a cation exchange layer consisting of zirconium phosphate; iv) an anion exchange layer consisting of hydrated zirconium oxide; and v) an adsorbent layer consisting again of activated carbon.

### INVENTION SUMMARY

A general object of the present invention is to provide a dialysate purification system comprising of at least one purification layer, at least one enzyme layer, at least one cation and anion exchange layers and at least one adsorbent layer.

In accordance with one aspect of the present invention, these and other objectives are accomplished by providing at least one purification layer comprising of an activated carbon to remove heavy metals, oxidants and chloramines.

In accordance with one aspect of the present invention, these and other objectives are accomplished by providing at least one enzyme layer comprising of at urease.

In accordance with one aspect of the present invention, these and other objectives are accomplished by providing an anion exchange layer comprising of apatite and/or calcium phosphate.

In accordance with one aspect of the present invention, these and other objectives are accomplished by providing a cation exchange layer comprising of sodium polyphosphate.

In accordance with one aspect of the present invention, these and other objectives are accomplished by providing at least one phosphate binder layer comprising of calcium acetate and calcium carbonate.

In accordance with one aspect of the present invention, these and other objectives are accomplished by providing at least one absorbent layer comprising of activated carbon.

In accordance with one aspect of the present invention, these and other objectives are accomplished by providing a concurrent method whereby dialysate passes through a system comprising of at least one purification layer, at least one enzyme layer, at least one cation exchange layer, at least two anion exchange layers, at least three purification layers, at least one phosphate binder layer and at least one absorbent layer.

In accordance with one aspect of the present invention, these and other objectives are accomplished by providing a concurrent method whereby dialysate passes through a purification layer comprising of activated carbon, an enzyme layer comprising of urease, a cation exchange layer comprising of sodium polyphosphate, an anion exchange layer comprising of apatite/calcium phosphate, an absorbent layer comprising of activated carbon, a purification layer comprising of activated carbon, a phosphate binding layer comprising of calcium acetate, an anion exchange layer comprising of apatite/calcium phosphate and a purification layer comprising of carbon or activated carbon.

The above described and many other features and attendant advantages of the present invention will become apparent from a consideration of the following detailed description when considered in conjunction with the accompanying drawings.

### BRIEF DESCRIPTION OF THE DRAWINGS

FIG. 1 is a diagram comparing the present invention over the prior art;

FIG. 2 is a diagram describing the concurrent dialysate system.

### DETAILED DESCRIPTION OF THE PREFERRED EMBODIMENTS

This description is not to be taken in a limiting sense, but is made merely for the purpose of illustrating the general principles of the invention. The section titles and overall organization of the present detailed description are for the purpose of convenience only and are not intended to limit the present invention.

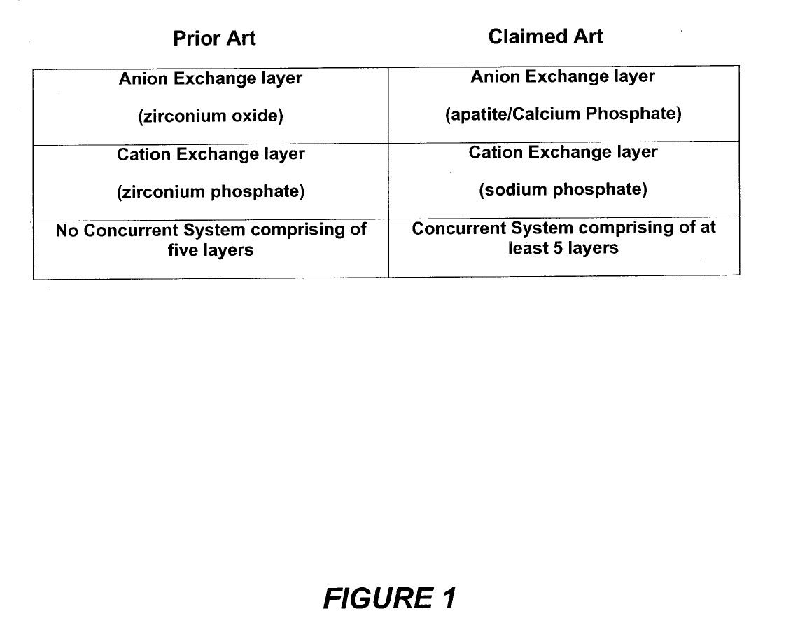

FIG. 1 describes the differences between the present invention versus that of the prior art, for example, the REDY sorbent system. As discussed previously the prior art typically consists of five layers: adsorbent, anion exchange, cation exchange, urease and purification. The dialysis flow rate of the prior art is typically in the range of 250 ml/min.

For example, the prior art uses a zirconium oxide layer (anion exchange layer) to bind negatively charged molecules including phosphates, fluoride, heavy metals and other anions. In contrast, the present invention binds negatively charged molecules using apatite and/or calcium phosphate (apatite is a naturally occurring phosphate mineral consisting of basic calcium phosphate).

In another example, the prior art uses a zirconium phosphate layer (cation exchange layer) positively charged molecules including ammonium, calcium, magnesium, potassium and other cations. In contrast, the present invention binds positively charged molecules using sodium polyphosphate.

In another example, the prior art consists of five layers. In contrast, the present invention comprises at least 9 layers: at least two adsorbent layers, at least two anion exchange layer, at least one cation exchange layer, at least one phosphate binding layer and at least two purification layers.

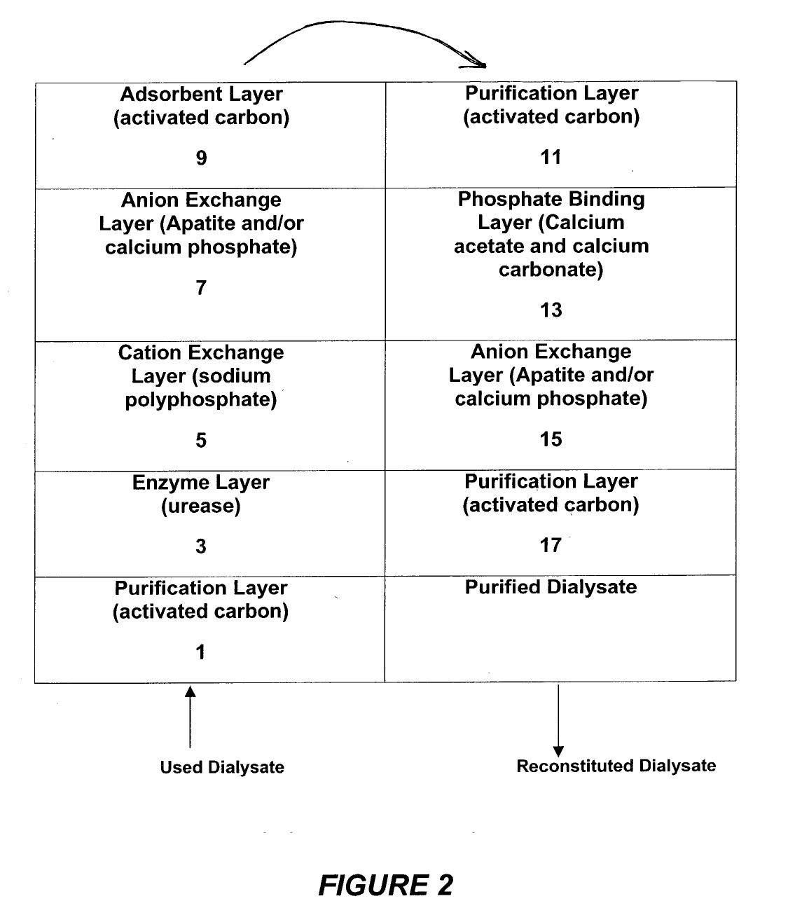

FIG. 2 describes the concurrent dialysate system of the present invention comprising of at least five layers, and in another embodiment, at least nine layers.

First, used dialysate passes through a purification layer 1 to remove heavy metals, oxidant and chloramines. Secondly, the dialysate then passes through an enzyme layer 3, which converts urea to ammonium carbonate. Thirdly, the ammonium carbonate (or dialysate) passes through a cation exchange layer 5, which binds various positively charged molecules including ammonium, calcium, magnesium, potassium and other cations. Fourthly, the dialysate passes through an anion exchange layer 7, which binds various negatively charged molecules including phosphate, fluoride and heavy metals. Next, the dialysate passes through at least one adsorbent layer 9 and at least one purification layer 11. The dialysate then passes through a phosphate-binding layer 13, and another anion exchange layer 15. Lastly, the dialysate passes through a purification layer 17 before the spent dialysate is removed.

In another embodiment, the purification layer is activated carbon 1, 11, 17 to remove heavy metals, oxidant and chloramines. The enzyme layer is a urease layer 3, which converts urea to ammonium carbonate. The cation exchange layer is a sodium polyphosphate 5, which binds various positively charged molecules including ammonium, calcium, magnesium, potassium and other cations. The phosphate-binding layer is calcium acetate and calcium carbonate 13. The anion exchange layer is an apatite/calcium phosphate layer 7,15, which binds various negatively charged molecules including phosphate, fluoride and heavy metals. The adsorbent layer is activated carbon 9.

Accordingly, the invention is not limited to the precise embodiments described in detail hereinabove. For example, FIG. 2 is one embodiment of a concurrent purification cartridge for use in hemodialysis, other concurrent purification cartridges with fewer or more of one of the layers is also within the scope of the invention. In another example, the present invention and modifications of the present invention can be utilized with existing hemodialysis machines, or the present invention can be incorporated as part of a a stand-alone machine (i.e. portable).

Advantages of the present invention include cost effectiveness and efficiency. For example, zirconium phosphate and zirconium oxide are expensive ingredients. Whereas, sodium polyphosphate and apatite/calcium phosphate are inexpensive. In another example, prior art sorbent hemodialysis systems filter the dialysate only once and at a rate of 250 ml/min. Whereas, the present invention is a concurrent purification cartridge which filters the dialysate at least twice at a rate of about 500 ml/min. Variations of the present invention, for example, added anion and cation exchange layers or purification layers, may change this rate.

While the specification describes particular embodiments of the present invention, those of ordinary skill can devise variations of the present invention without departing from the inventive concept.

We claim:

1. A concurrent purification cartridge for use in hemodialysis comprising:
a) at least two purification layers;
b) at least one enzyme layer;
c) a least one cation exchange layer;
d) at least two anion exchange layers;
e) at least one absorbent layer; and
f) at least one phosphate binding layer.

2. A concurrent purification cartridge of claim 1, whereby the anion exchange layer is comprised of at least one of apatite and calcium phosphate.

3. A concurrent purification cartridge of claim 1, whereby the cation exchange layer is comprised of sodium polyphosphate.

4. A concurrent purification cartridge of claim 1, whereby the phosphate binding layer is comprised of at least one of calcium acetate and calcium carbonate.

5. A concurrent purification cartridge of claim 1, whereby the anion exchange layer is not comprised of zirconium oxide.

6. A concurrent purification cartridge of claim 1, whereby the anion exchange layer is not comprised of zirconium phosphate.

7. A concurrent purification cartridge of claim 1, whereby the flow rate is about 500 ml/min.

8. A concurrent purification cartridge for use in hemodialysis comprising:
a) at least two purification layers comprised of activated carbon;
b) at least one enzyme layer comprised of urease;
c) a least one cation exchange layer comprised of sodium polyphosphate;
d) at least one anion exchange layer comprised of apatite and/or calcium phosphate;
e) at least one absorbent layer comprised of activated carbon; and
f) at least one phosphate binding layer comprised of calcium acetate and calcium carbonate.

9. A concurrent purification cartridge of claim 8 comprised of more than two anion exchange layers.

10. A concurrent purification cartridge of claim 8, whereby the anion exchange layer is not comprised of zirconium oxide.

11. A concurrent purification cartridge of claim 8, whereby the anion exchange layer is not comprised of zirconium phosphate.

12. A concurrent purification cartridge of claim 8, whereby the flow rate is about 500 ml/min.
